(19) United States
(12) Patent Application Publication
(10) Pub. No.: US 2026/0065660 A1
(43) Pub. Date: Mar. 5, 2026

(54) ENCODER-BASED OBJECT DETECTION BASED ON DATA FROM AN ENVIRONMENTAL SENSOR

(71) Applicant: Robert Bosch GmbH, Stuttgart (DE)

(72) Inventors: Alexander Bartler, Villingen-Schwenningen (DE); Bastian Bischoff, Gerlingen (DE); Csaba Domokos, Simmozheim (DE); Daniel Niederloehner, Stuttgart (DE); Holger Wunsch, Tuebingen (DE); Jan Bechtold, Ebringen (DE); Kilian Rambach, Stuttgart (DE); Marcel Schreiber, Neu-Ulm (DE); Maurice Quach, Ditzingen (DE); Michael Ulrich, Stuttgart (DE)

(21) Appl. No.: 19/294,398

(22) Filed: Aug. 8, 2025

(30) Foreign Application Priority Data
Aug. 29, 2024 (DE) 10 2024 208 209.0

(51) Int. Cl. G06V 10/82; G06V 10/764; G06V 20/70

(52) U.S. Cl. CPC G06V 10/82; G06V 10/764; G06V 20/70

(57) ABSTRACT

A system for detecting objects based on data from at least one environmental sensor. An encoder is configured to process encoder input data that specify data from the at least one environmental sensor, wherein a representation is generated from the encoder input data, which representation represents information about located objects that is contained in the encoder input data. An object detection model is configured to process the generated representation as model input data and to generate object hypotheses from the representation generated by the encoder. The object hypotheses in each case include an object position and/or object features, wherein the object features comprise at least one of a bounding box and a classification.

### CROSS REFERENCE

The present application claims the benefit under 35 U.S.C. § 119 of Germany Patent Application No. DE 10 2024 208 209.0 filed on Aug. 29, 2024, which is expressly incorporated herein by reference in its entirety.

### FIELD

The present invention relates to a system for detecting objects on the basis of data from at least one environmental sensor.

### BACKGROUND INFORMATION

Advanced driver assistance systems (ADAS) and autonomous driving (AD) require an accurate representation of the vehicle's surrounding area. In addition to cameras, point-based sensors (location sensors) such as lidar or radar are also used for this purpose. These sensors provide measurements, e.g., in the form of point clouds. A lidar sensor, for example, characterizes each point by a Cartesian coordinate (x, y, z) and the reflection intensity, while a radar sensor provides, for instance, a polar coordinate (distance, azimuth angle) and other properties such as signal strength, radar cross section (RCS), elevation angle, etc. The position, orientation, class and, if applicable, other properties of relevant objects (e.g., cars, trucks or pedestrians) can then be determined. Traditionally, perception algorithms comprise an object tracking step (typically based on a Kalman filter), followed by a classification of an object type. Object tracking comprises a model that describes what objects look like in the sensor data (e.g., a reflection model for radar sensors or an L-shaped vehicle model for lidar sensors). With the advent of deep learning, traditional perception algorithms are increasingly being replaced by neural networks and, in particular, object detection networks. Typically, a neural network for object detection outputs oriented bounding boxes (OBBs) with the existence probability, size, orientation and class of the objects. Only then are the recognized OBBs tracked over time.

One advantage of neural networks is that they enable the development of systems in a data-driven manner. However, they are usually uninterpretable, and it is often difficult to correct network failures observed in the test dataset (the part of the dataset not used for training) or in the real world. In fact, retraining the network for these specific cases may not fix the errors and may even degrade performance in cases where the network previously performed well. An error is understood to mean an incorrect or non-existent detection of an object.

On the other hand, traditional approaches require considerable development effort to achieve satisfactory performance. However, their behavior is more predictable, and errors can be corrected, because the behavior of the system is more interpretable than with neural networks. Improvements to the system can be made in a way that addresses, verifiably or with high certainty (compared to neural networks), the targeted errors without affecting existing, previously well-functioning scenarios. This is particularly crucial for justifying security.

### SUMMARY

One object of the present invention is to provide a novel system for detecting objects on the basis of data, in particular location data, from at least one environmental sensor, which avoids or mitigates the respective disadvantages of neural networks and traditional approaches. It is a particular object of the present invention to provide a system for detecting objects on the basis of data from at least one environmental sensor, which system combines advantageous properties of neural networks and traditional approaches, while avoiding or mitigating their respective disadvantages. It is desirable that the system is interpretable or allows for error resolution with reasonable effort, while at the same time allowing the benefits of data-driven approaches to be exploited.

One or more of the objects may be achieved by certain features of the present invention. Advantageous embodiments or further developments of the present invention are disclosed herein.

The present invention is a hybrid approach between a neural network and a conventional or traditional approach (in particular an object detection model). According to the approach, a neural network is used to encode, e.g., radar data into a hidden representation, and a conventional (or traditional) approach performs object detection (object recognition) on the basis of this hidden representation. The conventional approach is ideally interpretable and allows errors to be addressed in a meaningful way. As a result, the hybrid approach is also more interpretable and allows for easier processing of errors than a method based solely on a neural network. Here and below, a neural network always refers to an artificial neural network.

According to one aspect of the present invention, a system for detecting objects on the basis of data from at least one environmental sensor is specified. The system comprises an encoder, wherein the encoder is configured to process encoder input data that specify data from the at least one environmental sensor. The processing of the encoder input data comprises generating a representation from the encoder input data, wherein the representation represents information about located objects (of the environmental sensor) that is contained in the encoder input data. The system further comprises an object detection model, wherein the object detection model is configured to process a representation generated by the encoder as model input data. The processing of the model input data comprises generating object hypotheses from the representation generated by the encoder, wherein the object hypotheses in each case comprise or specify an object position and/or object features. The object features comprise at least one of a bounding box and a classification. The object features can also be called object properties.

According to an example embodiment of the present invention, the system can in particular be an environmental detection system for motor vehicles. The environmental detection system can, for example, be an environmental detection system for detecting a traffic environment, in particular an environmental detection system for motor vehicles or a (e.g., stationary) traffic detection system. In an environmental detection system for motor vehicles, the at least one sensor can be a sensor for providing location data about objects in the environment of the motor vehicle.

According to an example embodiment of the present invention, the system can comprise a control and evaluation device for the at least one environmental sensor. The control and evaluation device can comprise the encoder and the object detection model. The system can comprise the at least one environmental sensor.

The data of the at least one environmental sensor can in particular be location data, for example location data of an environmental sensor in the form of a radar sensor or LiDAR sensor. Alternatively, the data can also comprise an image, for example an image from an image sensor, e.g., a camera image from a camera. The data can be obtained from the environmental sensor or can be pre-processed.

The data are input into the encoder, which converts the data into the representation (encodes the data into the representation). The representation is then passed as input to the object detection model (which can be constructed, e.g., according to a conventional or traditional method). Depending on the task of detecting (recognizing) objects, the model then outputs, e.g., OBBs including the probability of existence, size, orientation, position and class of the objects. Alternatively, the model can also be configured to generate classifications as object hypotheses. The classifications can comprise or be classification probabilities.

By combining the encoder and the object detection model, better performance can be achieved compared with strictly traditional methods. The combination of the encoder and the object detection model also allows better interpretability compared to approaches based on neural networks alone. In addition, due to the object detection model (e.g., a traditional part of the system), a justification of the security of the system can be achieved more easily. It is also particularly advantageous that error cases can be handled (i.e., the system can be improved to handle these cases better) with only minimal or no impact on scenarios for which the system already works well. It is also advantageous that the system can be constructed in a simpler (less complex) way using an end-to-end neural network (which generates object hypotheses from the data/location data). The system therefore facilitates implementation on integrated (embedded) hardware.

The system can be adapted to different tasks. Thus, actual object detection can be a task. However, the representation can also be used for one or more tasks, including, for example, semantic segmentation, classification, etc. Here, semantic classification is understood to mean that a classification of individual units of the representation takes place (in contrast to the classification of detected/complete objects).

In example embodiments of the present invention, the data (of the at least one environmental sensor) comprise location data. The location data comprise at least one of a point cloud that comprises individual points and a grid that comprises grid cells.

Grid cells of a grid can contain locations or be empty. Coordinates or indices of the grid can correspond to spatial coordinates (e.g., relative to the sensor position). Spatial coordinates can correspond to a forward direction and a lateral or transverse direction. In the case of a 3D grid, e.g., a coordinate of the grid can also correspond to a height direction.

The location data can comprise location data in the form of a point cloud, in particular a point cloud including features, i.e., features of the points. The location data can be entered into the encoder in the form of a list of (unordered) points as encoder input data. The order or sequence of the points is not relevant.

The location data can comprise measured location data. The location data can be obtained from the environmental sensor or can be pre-processed. Points of a point cloud or “filled” grid cells can correspond to individual locations or reflections, for example reflections of radar signals or LiDAR signals from an environmental sensor. Each point or grid cell can exhibit certain properties (also called features), e.g., a radar cross section (RCS) and/or a radial velocity (compensated by the self-movement of the environmental sensor).

The encoder can comprise or be at least one artificial neural network. The encoder can be part of a neural network architecture.

The encoder can also be called an encoder network. The encoder can in particular comprise at least one recurrent neural network or at least one neural network with a transformer architecture. Recurrent neural networks are a class of artificial neural networks that comprise connections between neurons or nodes of one layer to neurons or nodes of the same or previous layer. A neural network with a transformer architecture is also called a transformer and is a deep learning architecture.

The encoder can be constructed according to a decoder of an encoder-decoder model. The encoder can be constructed according to an encoder of an autoencoder.

According to an example embodiment of the present invention, preferably, the encoder comprises a first encoder layer and at least one second encoder layer. The first encoder layer is preferably configured to process the encoder input data as input. The second (or a final second) encoder layer is preferably configured to generate the representation.

The encoder is particularly configured to convert the encoder input data into the representation. In particular, the representation can be or comprise a different representation or encoding of the data or location data than the encoder input data.

The representation can have a lower dimensionality (dimension or size) than the encoder input data. The encoder can be configured to detect relevant features or samples (related to objects) in the encoder input data and to reproduce them in the representation.

In example embodiments of the present invention, the representation comprises a plurality of units, or the representation is divided into a plurality of units. The units can in each case comprise a feature vector (features). The unit can be identical to the feature vector. The unit is assigned a position within the representation (e.g., on the basis of indices or coordinates that identify the unit). Coordinates, indices or the position of a unit of the grid can correspond to spatial coordinates, in particular Cartesian spatial coordinates (e.g., relative to a position of an environmental sensor). Spatial coordinates can be 2D spatial coordinates or 3D spatial coordinates.

In example embodiments of the present invention, the representation comprises at least one point cloud that comprises individual points or at least one grid that comprises grid cells. The points can be units of the representation. The grid cells can be units of the representation. The grid can correspond to the environment of the at least one environmental sensor.

The representation can also be referred to as a hidden or latent representation. It can be a (hidden) representation of the encoder input data. The representation can be, e.g., a point cloud with feature vectors (features) or a grid with feature vectors (features). These features can also be called hidden features. Units of the representation can be, for example, grid cells (of a grid) or points (of a point cloud). For example, a particular unit of the representation can comprise a feature vector. The feature vector can be associated with the unit in question (e.g., the grid cell). The representation can, for example, comprise or be a 2D grid or a 3D grid. The output of the encoder can be the input of the object detection model.

In example embodiments of the present invention, the representation can comprise a plurality of grids, which in each case comprises grid cells. Each grid can correspond to the environment of the at least one environmental sensor. Each grid can be a representation that represents information about located objects that is contained in the encoder input data. In particular, information about a located object can be represented in a plurality of or each of the plurality of grids.

The object detection model is a model or algorithm configured to process the representation generated by the encoder as model input data. The object detection model converts the obtained representation into object hypotheses. A generated object hypothesis can correspond to a detected object. The generated object hypotheses can be output as system output. The output of the object detection model or of the system can be a list of the object hypotheses or a set of the object hypotheses.

The object hypotheses in each case comprise an object position and/or object features. The object features comprise at least one of a bounding box and a classification. The object hypotheses represent predictions of objects or their features. The object hypotheses correspond in particular to probable objects that were located according to the data or location data by the at least one environmental sensor.

In one example embodiment of the present invention, the object hypotheses in each case comprise a classification of an object type (type of object), an object position (position of the object), dimensions of the object or of a bounding box corresponding to the object, and/or an orientation of the object or of the bounding box. The dimensions can comprise, in particular, length and width. The dimensions can also comprise a height. In one example, the object hypotheses in each case comprise a classification of an object type, wherein the classification comprises a particular classification probability for at least one object class.

The object detection model can comprise an (already trained) machine learning algorithm. The object detection model can be a machine learning algorithm.

In a simple case, the object detection model can comprise a nearest neighbor algorithm, for example a k-nearest neighbor algorithm. The object detection model can be a nearest neighbor algorithm, i.e., a nearest neighbor-based search. The object detection model can comprise a database (or databank).

In another case, the object detection model can comprise a decision tree algorithm, in particular a gradient boosted algorithm or gradient boosted tree algorithm.

In example embodiments of the present invention, the object detection model comprises a database in which feature vectors are stored together with respectively associated object data. The feature vectors can be stored individually with respectively associated object data. However, the feature vectors can also be stored as feature vectors of units of a representation together with object data respectively associated with the feature vectors or units. This means that representations can be stored together with object data respectively associated with their units or feature vectors. The database can store pairs (associations) of representations or feature vectors and object data associated with the respective feature vectors. The object detection model can be configured to generate the object hypotheses from the representation generated by the encoder, which comprises feature vectors, on the basis of the database. The object detection model can in particular be configured to generate the object hypotheses from the representation generated by the encoder on the basis of the database by means of a nearest neighbor algorithm or a k-nearest neighbor algorithm. The nearest neighbor algorithm or k-nearest neighbor algorithm can be configured to search in the database for one or more nearest neighbors to a feature vector of a particular unit of the representation generated by the encoder. The algorithm can be configured to evaluate the associated object data, in particular to generate the object hypotheses on the basis of the associated object data. The object detection model can be configured to generate object hypotheses by means of interpolation between associated object data of a plurality of nearest neighbors. The nearest neighbors can be searched or determined unit by unit. The nearest neighbors to a feature vector of a unit of the representation can be searched across unit positions (across representations), i.e., in particular among all units of stored representations. The nearest neighbor of a unit/grid cell at position (x1, y1) can be, for example, a unit of a stored representation at another position (x2, y2). The nearest neighbor algorithm or a k-nearest neighbor algorithm is part of the object detection model. Alternatively, the nearest neighbor algorithm or a k-nearest neighbor algorithm can be configured to search the database for one or more nearest neighbors to the representation generated by the encoder. Namely, nearest neighbors are searched for in the form of representations as a whole.

If the algorithm searches for one or more nearest neighbors to respective feature vectors of units of the representation generated by the encoder, the object hypothesis can be composed of respective evaluations of the one or more nearest neighbors. For each object position of the object hypothesis, a basic position corresponding to a position (or coordinates) of the unit in question within the representation can be taken into account. The position of a unit in the representation contains information about spatial coordinates, e.g., a (rough) object position. The particular feature vector can comprise information about a relative object position, wherein the relative object position specifies the object position relative to a position (or spatial coordinate) corresponding to the unit.

By storing feature vectors and in each case associated object data in the database, it is particularly easy and safe to correct a specific error. For correcting a data scenario that is not detected or is not correctly detected, a feature vector (or a corresponding representation) in question can for example be added to the database together with target object data as the associated object data. This feature vector (or representation) then becomes the nearest neighbor (with a distance of zero). Already well-processed, existing scenarios are hardly affected, due to the properties of the nearest neighbor search as well. This is particularly advantageous if certain error scenarios need to be resolved.

The associated object data can, e.g., in each case describe one or more objects along with features of the objects (object features). The associated object data can in each case specify an object position and/or object features. The object features comprise at least one of a bounding box and a classification. In particular, the associated object data can describe features that correspond to the object features of the object hypotheses generated by the object detection model. Thus, they can, for example, in each case comprise a classification of an object type (type of object), an object position (position of the object), dimensions of the object or of a bounding box corresponding to the object and/or an orientation of the object or of the bounding box. The dimensions can comprise, in particular, length and width. The dimensions can also comprise a height. The object position can be a relative object position, in particular relative to the position (the spatial coordinates) of a unit of representation. Alternatively, the object position can be an overall object position, in particular relative to an entire representation.

The object hypotheses generated by the object detection model can in each case comprise an object position determined on the basis of spatial coordinates corresponding to a unit in question of the representation generated by the encoder and on the basis of a relative object position of stored or interpolated stored object data.

In example embodiments of the present invention, the system comprises a non-maximum suppression (NMS) algorithm that is configured to filter the object hypotheses generated by the object detection model. The algorithm can be part of the object detection model.

For example, if an object can extend over a plurality of grid cells (units), object hypotheses can overlap (spatially, in the grid). These can be filtered by means of the non-maximum suppression algorithm in order to ascertain a probable correct object hypothesis (without overlap with other object hypotheses). For each object, the NMS algorithm can select from (spatially) overlapping object hypotheses, e.g., the one that has the highest object probability as the object hypothesis. Thus, the NMS algorithm can be configured to select, in the case of a plurality of overlapping object hypotheses, one of the overlapping object hypotheses that is correct with maximum probability as the object hypothesis.

In example embodiments of the present invention, the representation comprises a plurality of units, which in each case comprise a classification vector, wherein the components of the classification vector are multi-valued numbers. In particular, a feature vector of the unit can comprise or be the classification vector. The encoder can, for example, comprise a label embedding network or a classification part of a label embedding network, or the encoder can correspond to a classification part of a label embedding network (be constructed accordingly). The components can be floating-point numbers, for example. Predefined classes can be assigned respective classification vectors.

In a conventional classification vector using one-hot encoding, different object types are assigned to different indices or components of the vector, and a component set to 1 corresponds to a classification of the assigned object type. In contrast, label embedding or classification vectors with multi-valued components can provide a better mapping of real object types to the classification vectors. In particular, it can be achieved that similar objects are encoded with similar classification vectors. It is advantageous that class hierarchies or class relationships can be mapped or represented. Classification vectors can be defined that form a hierarchy in the vector space. In addition, it is advantageous that a better alignment of the feature space can be achieved and that suitability for the use of foundation models (basic models or base models) can be achieved. In particular, the feature space can be better aligned to the semantic meanings of the classes than with one-hot encoding. Foundation models can also be used to define the class vectors.

The encoder can be configured to represent relatively more similar objects by relatively more similar classification vectors in the representation and to represent relatively more dissimilar objects by relatively more dissimilar classification vectors.

The object detection model can be configured to convert a particular classification vector of a unit of the representation into a classification of an assigned object hypothesis.

In a nearest neighbor algorithm, the distance between the classification vectors can be calculated according to the Euclidean distance or according to another distance function, for example, the least cosine similarity (which evaluates the cosine of the angle between the vectors).

In example embodiments of the present invention, the processing of the model input data by the object detection model comprises determining a classification of a particular object hypothesis from at least one particular classification vector of the representation. This can be carried out in particular by means of the nearest neighbor algorithm or a k-nearest neighbor algorithm, as explained above for feature vectors.

In example embodiments of the present invention, the object detection model is configured to determine at least one classification probability for a classification of an object hypothesis on the basis of a distance between a classification vector of the representation and at least one specified class vector. The classification can correspond to a specified class vector. The classification probability can specify an uncertainty measure for the classification. Thus, the advantage is achieved that an interpretable uncertainty measure can be determined on the basis of the distance between the feature vectors or classification vectors from the class vectors. For example, a particular classification probability can be determined for a plurality of classifications of an object hypothesis (e.g., the following classification probabilities can be determined for an object: 20% background, 60% passenger car, 20% truck).

In example embodiments of the present invention, the encoder comprises at least the first, the first two or all of the following components:
at least one layer configured to convert the encoder input data into a first representation in the form of a grid;
a backbone network configured to convert the first representation into a second representation in the form of a plurality of grids;
a plurality of detection heads configured to convert the second representation into a third representation in the form of a plurality of grids, wherein the plurality of detection heads are in each case configured to convert at least one of the plurality of grids of the second representation into a particular grid of the third representation.

The third representation can be a representation in the form of a plurality of grids with classification probabilities or with feature vectors that describe classifications. A particular detection head can be configured to convert one of the plurality of grids of the second representations assigned to it into a grid of the third representation. A particular detection head can also be configured to convert the plurality of grids of the second representations into a grid of the third representation. Grid cells of the first grid and the second grid can in each case comprise feature vectors.

In example embodiments of the present invention where the object detection model comprises the database, the representations stored in the database can correspond to the first representation, correspond to the second representation or correspond to the third representation, or the feature vectors stored in the database can correspond to units of the first representation, correspond to units of the second representation or correspond to units of the third representation.

The other components mentioned (i.e., the plurality of detection heads, or the backbone network and the plurality of detection heads) can also be components of the object detection model, for example.

The encoder can be created by means of different methods. The encoder can be created by means of autoencoder training. For example, the encoder can correspond to a part of an autoencoder that has been trained. The autoencoder can comprise the encoder and an associated decoder. The encoder generates a (hidden) representation from the encoder input data. The decoder generates a reconstruction of the encoder input data from the representation. For example, the autoencoder can be trained so that similar inputs (encoder input data) generate as similar outputs (of the decoder of the autoencoder) as possible. The encoder can be used in the system, i.e., the encoder is used in the system for inference or reasoning.

Alternatively, the encoder can also be trained without a decoder. The encoder can be trained, for example, by means of contrastive learning. The encoder is trained with a set of encoder input data so that similar encoder input data generate similar representations and dissimilar encoder input data generate dissimilar representations. The advantage is that similar input data can be generated from an existing training dataset through data augmentation in a way that does not change the semantics to be achieved. Thus, the training dataset can be increased on the basis of data. For example, for point clouds, additive noise on the features and rotations can be used to enlarge the training dataset.

The training of the encoder can be self-supervised or unsupervised.

According to an example embodiment of the present invention, a further option is to train the encoder together with the object detection model by means of backpropagation (also known as error feedback). In this situation, the system is trained end-to-end. This requires that the object detection model is differentiable or that a differentiable approximation can be used for the object detection model.

In the object detection model, a distinction is made between the training phase and the inference (reasoning) phase. An available dataset is typically divided into a training dataset and a test dataset.

With a nearest neighbor algorithm or a k-nearest neighbor algorithm, the training of the object detection model can be carried out by the encoder generating a corresponding representation for each sample. For each grid cell (each unit) of the representation, the corresponding feature vector can be stored along with the associated object data according to the expected output (e.g., an oriented bounding box, OBB). In particular, the feature vector can be associated with the occupancy, the object position and the object dimensions such as length, width, height and orientation. Thus, representations with feature vectors and the object data of one or more objects in each case associated with the feature vectors can be stored in the database.

During inference, the encoder converts the input data into its corresponding latent representation. Then, for each grid cell (or unit), a nearest-neighbor search finds the feature vector that is most similar/closest to that of the grid cell in question. Finally, the output of the object detection model includes the occupancy, object position and dimensions that are associated with the feature vector that is found. Alternatively, k nearest neighbors can be found, k≥1, and any kind of interpolation and/or aggregation can be performed in order to obtain a next result.

In the following, exemplary embodiments of the present invention are explained in more detail with reference to the figures.

### BRIEF DESCRIPTION OF THE DRAWINGS

FIG. 1 is a schematic diagram of a system for detecting objects according to example embodiments of the present invention.

FIG. 2 is a schematic diagram of a system for detecting objects according to example embodiments of the present invention with a nearest neighbor algorithm.

FIG. 3 is a schematic diagram of a system for detecting objects according to further example embodiments of the present invention.

FIGS. 4A and 4B show schematic examples of classification vectors.

### DETAILED DESCRIPTION OF EXAMPLE EMBODIMENTS

In the figures, identical or corresponding features are identified by the same reference numerals.

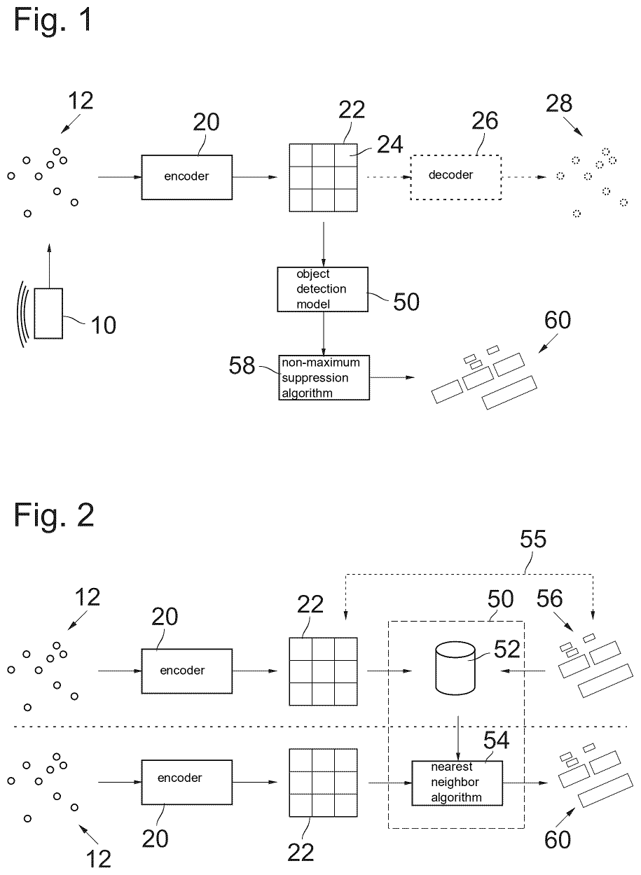

The system shown in FIG. 1 for detecting objects on the basis of data from at least one environmental sensor 10 comprises the environmental sensor 10, an encoder 20 and an object detection model 50.

The encoder 20 is configured to process encoder input data that specify data 12, namely location data of the at least one environmental sensor 10 in the form of a point cloud. The processing of the encoder input data comprises generating a latent representation 22 from the encoder input data. The representation 22 represents information about objects located by the environmental sensor 10 that is contained in the encoder input data.

The object detection model 50 is configured to process the representation 22 generated by the encoder 20 as model input data. The processing of the model input data comprises generating object hypotheses 60 from the representation 22 generated by the encoder 20. The object hypotheses 60 in each case comprise an object position and object features, wherein the object features comprise a bounding box and a classification.

The representation 22 is a grid that comprises units 24 of the representation 22 in the form of grid cells. A unit 24 comprises, for example, a representation of an object as a feature vector.

The system optionally comprises a non-maximum suppression algorithm 58 that is configured to filter the object hypotheses 60 generated by the object detection model 50.

The trained encoder 20 can be generated by means of an associated decoder 26. The encoder 20 and the decoder 26 are trained together, wherein the encoder 20 converts input data 12 into a latent representation 22 and the decoder 26 generates reconstructed data 28 from the latent representation 22, which data represent a reconstruction of the input data 12.

FIG. 2 shows a system for detecting objects in which the object detection model 50 comprises a database 52 and a nearest neighbor algorithm 54. Above the dashed horizontal line, the training of the object detection model 50 is shown, below the line the inference, in particular the application in practice. The application can correspond to the system shown in FIG. 1.

During the training phase, the system stores associations 55 between latent representations 22 and ground truth data in the form of object data 56. The object data 56 are oriented bounding boxes having positions and classification. The object data 56 can, for example, be stored as a vector (dx, dy, dz, l, w, h, yaw), where dx, dy, dz are relative positions along the x, y, z axes within the associated grid cell, l, w, h are length, width and height, and yaw is a yaw angle.

During the inference phase, the system finds the nearest neighbor of the latent representation 22; more precisely, for the units 24 of the representation 22, the nearest neighbor algorithm 54 finds in each case the nearest neighbor among the units of the representations 22 stored in the database 52. The associated ground truth object data 56 (or interpolated results) are output as object hypotheses 60 in the form of predicted oriented bounding boxes.

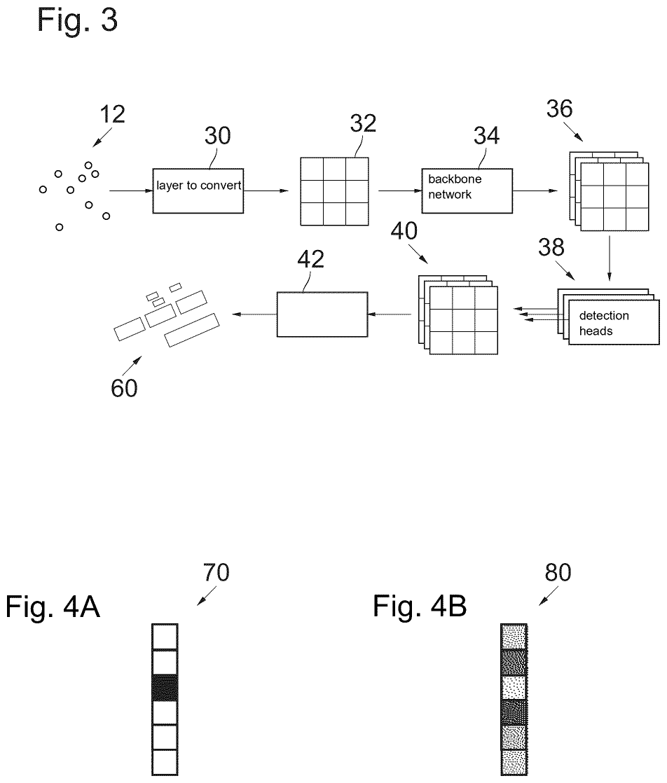

FIG. 3 schematically shows a system for detecting objects, which receives as input data 12 in the form of a point cloud and outputs detected bounding boxes as object hypotheses 60. The system comprises a radar object detection network as the encoder 20. In particular, a classification part of the network can represent the encoder 20.

The system comprises at least one layer 30 configured to convert the encoder input data into a first representation 32 in the form of a grid. A backbone network 34 is configured to convert the first representation 32 into a second representation 36 in the form of a plurality of grids with feature vectors. The grids can comprise different scales and/or sizes and in each case represent the entire field of view of the sensor 10. A plurality of detection heads 38 are configured to convert the second representation 36 into a third representation 40 in the form of a plurality of grids. The plurality of detection heads 38 can in each case process a grid of the second representation 36, or the entire second representation 36. The representations are converted by the respective detection heads 38 into respective grids of a third representation 40.

The radar object detection network comprises a label embedding network. The latent representations 40 are grids having class probabilities that are predicted by the detection heads 38.

FIG. 4A schematically shows a classification vector 70 according to a conventional one-hot coding. For k classes, a vector of length k is generated, which has a value of 1 for the corresponding class and a value of 0 for all other classes. FIG. 4B shows a classification vector 80 that is defined according to a label embedding method with specific values for each class. The individual components are, e.g., floating-point numbers.

A classification procedure then predicts a vector of the same size. This is then converted (by the object detection model 60) into a corresponding class. According to the above description, the class of the nearest neighbor vector can be selected (according to the Euclidean distance). However, other distance functions can also be used, e.g., the least cosine similarity.

Experiments have shown that label embedding can significantly improve detection performance.

Alternatively, one of the intermediate results of the network of FIG. 3 can be used as the latent representation 20. The example of label embedding is a special case where the latent representation 40 corresponds to the final output of the neural network.

What is claimed is:

1. A system for detecting objects based on data from at least one environmental sensor, the system comprising:
an encoder configured to process encoder input data that specify data from the at least one environmental sensor, wherein the processing of the encoder input data includes generating a representation from the encoder input data, wherein the representation represents information about located objects that is contained in the encoder input data; and
an object detection model configured to process a representation generated by the encoder as model input data, wherein the processing of the model input data includes generating object hypotheses from the representation generated by the encoder, wherein the object hypotheses in each case include an object position and/or object features, wherein the object features include at least one of a bounding box and a classification.

2. The system according to claim 1, wherein the data include location data that include at least one of a point cloud that includes individual points and a grid that includes grid cells.

3. The system according to claim 1, wherein the representation includes at least one point cloud that includes individual points or at least one grid that includes grid cells.

4. The system according to claim 3, wherein the representation includes a plurality of grids, which in each case include grid cells.

5. The system according to claim 1, wherein the object detection model includes a database in which feature vectors are stored together with respectively associated object data, wherein the object detection model is configured to generate the object hypotheses from the representation generated by the encoder, which representation includes feature vectors, based on the database using a nearest neighbor algorithm or a k-nearest neighbor algorithm.

6. The system according to claim 5, wherein the nearest neighbor algorithm or k-nearest neighbor algorithm is configured to search in the database for one or more nearest neighbors to a feature vector of a particular unit of the representation generated by the encoder.

7. The system according to claim 1, further comprising a non-maximum suppression algorithm that is configured to filter the object hypotheses generated by the object detection model.

8. The system according to claim 1, wherein the representation includes a plurality of units, which in each case include a classification vector, wherein components of the classification vector are multi-valued numbers.

9. The system according to claim 7, wherein the object detection model is configured to determine at least one classification probability for a classification of an object hypothesis based on a distance between a classification vector of the representation and at least one specified class vector.

10. The system according to claim 1, wherein the encoder includes at least a first one or first two or all of the following components:
at least one layer configured to convert the encoder input data into a first representation in a form of a grid;
a backbone network configured to convert the first representation into a second representation in a form of a plurality of grids;
a plurality of detection heads configured to convert the second representation into a third representation in a form of a plurality of grids, wherein the plurality of detection heads are in each case configured to convert at least one of the plurality of grids of the second representation into a respective grid of the third representation.
